(19) United States
(12) Patent Application Publication
(10) Pub. No.: US 2008/0190749 A1
(43) Pub. Date: Aug. 14, 2008

(54) SAFETY SWITCH

(76) Inventors: Julian Poyner, Hazel Grove (GB); Suresh Ramanujan Nair, Amherst, NH (US); Derek Sawyer, Granada (ES); Derek Jones, Borgue Gallowway (GB)

Correspondence Address: ROCKWELL AUTOMATION, INC./BF, ATTENTION: SUSAN M. DONAHUE, E-7F19, 1201 SOUTH SECOND STREET, MILWAUKEE, WI, 53204, US

(21) Appl. No.: 11/674,536

(22) Filed: Feb. 13, 2007

(51) Int. Cl. H01H 9/20

(52) U.S. Cl. 200/334

(57) ABSTRACT

There is provided a safety switch arranged to allow the control of power supplied to an apparatus, wherein the safety switch is provided with a biometric sensor module arranged to obtain biological information from a user of the safety switch, such that activation of the safety switch is controlled via the biological information obtained.

### CROSS-REFERENCE TO RELATED APPLICATIONS

This application is a U.S. patent application and corresponds to Great Britain Patent Application number 0601990 filed Feb. 1, 2006, the disclosure of which is incorporated herein.

### BACKGROUND OF THE INVENTION

The present invention relates to safety switches.

A safety switch may be considered as an emergency electrical shut off switch, and either allows or prevents electricity from passing through it (i.e. it provides a closed circuit or an open circuit). If the safety switch is activated, such that it forms an open circuit, electricity will not pass to any apparatus to which the safety switch is connected.

Safety switches are often used in places where access to particular enclosures is to be restricted, such enclosures enclosing electrically operated machinery. For example, safety switches are often found in factories that use kinetic machinery powered by electricity. The safety switch may be used to prevent access to an enclosure containing the machinery when the machinery is in operation. Specifically, power will only be supplied to the machinery when the switch is closed, and this is conveniently achieved by the closure of a gate incorporated in the enclosure. When the gate is opened, the safety switch is activated, the circuit is broken, and the electrical power supply to the machinery is interrupted (i.e. the machinery cannot run when the gate is opened and the safety switch is thereby activated). Safety switches are well known in the art, and come in a variety of different forms.

A safety switch will usually comprise a switch mechanism that is housed in a housing and attached to part of a structure forming the enclosure. A protruding actuator (i.e. a key) may be attached to a gate which is movable relative to the enclosure and the safety switch mechanism. When the gate is closed, the actuator engages with the switch mechanism to allow supply of electrical power to the machinery. Alternatively, the actuator may not be attached to the gate. Although access to the enclosure is still achieved by insertion of the actuator into the switch mechanism, the mechanism can be located at any suitable point, and the actuator may be carried around by a user and used as and when necessary (i.e. in the same manner as a house key).

While safety switches are intended to be beneficial to workers using and moving around dangerous machinery within a factory (for example), it is not uncommon for the safety features to be circumvented or abused. For example, it may be that workers wish to inspect dangerous machinery while it is in operation. In order to do this a worker may obtain a replacement key, or fabricate a makeshift key for him/herself to engage with the safety switch mechanism such that the machinery may be operable even when the gate remains open. Since the purpose of the safety switch is to prevent such access to the enclosure when machinery is in operation, thereby maintaining the safety of the workers, the use of a replacement or unauthorised key is not desirable.

It is thus desired to obviate or mitigate at least one of the above-mentioned disadvantages.

### BRIEF DESCRIPTION OF THE INVENTION

According to a first aspect of the invention there is provided a safety switch arranged to allow the control of power supplied to an apparatus, wherein the safety switch is provided with a biometric sensor module arranged to obtain biological information from a user of the safety switch, such that activation of the safety switch is controlled via the biological information obtained.

According to a second aspect of the invention, there is provided a safety switch arranged to receive biological information from a biometric sensor module.

According to a third aspect of the invention, there is provided a method of operating a safety switch, the safety switch being arranged to allow the control of power supplied to an apparatus, and wherein the safety switch is provided with a biometric sensor module arranged to obtain biological information from a user of the safety switch, such that activation of the safety switch is controlled via the biological information obtained, and wherein the method comprises: obtaining biological information from a user wishing to activate the safety switch via the biometric sensor module; comparing the obtained biological information with authorised biological information from one or more users authorised to activate the safety switch; and activating the switch if the biological information obtained from the user matches the authorised biological information.

By incorporating a biometric sensor into the safety switch, access to an enclosure can be more readily controlled. This will help to prevent access by unauthorised users. For example, the safety switch may be provided with a fingerprint reader. The fingerprints read by the fingerprint reader may be compared with one or more stored (and authorised) fingerprints. Only users with authorised fingerprints can gain access to the enclosure.

### BRIEF DESCRIPTION OF THE DRAWINGS

Embodiments of the present invention will now be described, by way of example only, with reference to the accompanying drawings, in which:

FIG. 1a depicts an enclosure incorporating a prior art safety switch;

FIG. 1b depicts the prior art safety switch of FIG. 1a;

FIG. 2 depicts a safety switch according to an embodiment of the present invention;

FIGS. 3a and 3b illustrates operating principles of the embodiment of FIG. 2; and

FIGS. 4a and 4b depict another embodiment of the present invention.

### DETAILED DESCRIPTION OF THE PREFERRED EMBODIMENTS

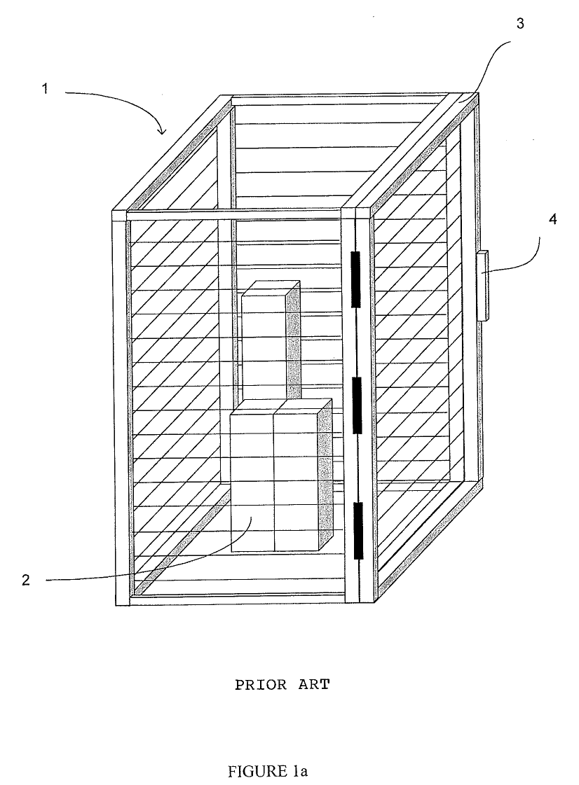

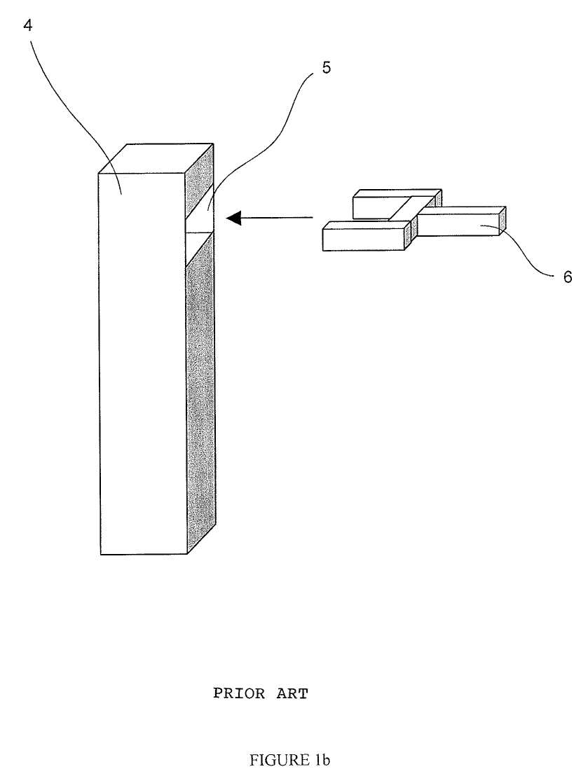

FIG. 1 depicts a perspective view of an enclosure 1 enclosing electrically powered machinery 2. Access to the machinery 2 within the enclosure 1 is gained via a gate 3. The gate 3 is provided with a prior art safety switch 4. The gate 3 is opened by activation of the safety switch 4. When a safety switch 4 is activated, supply of electricity to the machinery 2 is interrupted such that when a user enters the enclosure 1 by opening the gate 3, the machinery 2 is not functioning. For example, if the machinery 2 is electrically operated kinetic machinery, activation of the safety switch 4 will deactivate the machinery, and stop any movement thereof.

FIG. 1b shows how the safety switch 4 is activated. The safety switch 4 is provided with an opening 5, which is arranged to receive an actuator (e.g. a key) 6. If the actuator 6 is of the correct shape, engagement of the actuator 6 with the safety switch 4 via the opening 5 will cause the safety switch 4 to activate. As described above, when activated, the safety switch 4 interrupts power supply to the machinery 2 enclosed in the enclosure 1.

It will be appreciated that the known safety switch 4 provides a useful safety feature, whereby it is not possible to enter the enclosure 1 without electrical supply to machinery 2 enclosed therein being interrupted. However, the safety switch 4 of FIGS. 1a and 1b does not discriminate between different users. If the actuator 6 is of the correct shape, any user using that actuator 6 can gain access to the enclosure 1. It is therefore possible that unauthorised people may gain access to the enclosure 1 by obtaining copies of the actuator 6, or using the actuator 6 without authorisation. Such unauthorised use or copying circumvents the safety features provided by the safety switch 4, and this is undesirable.

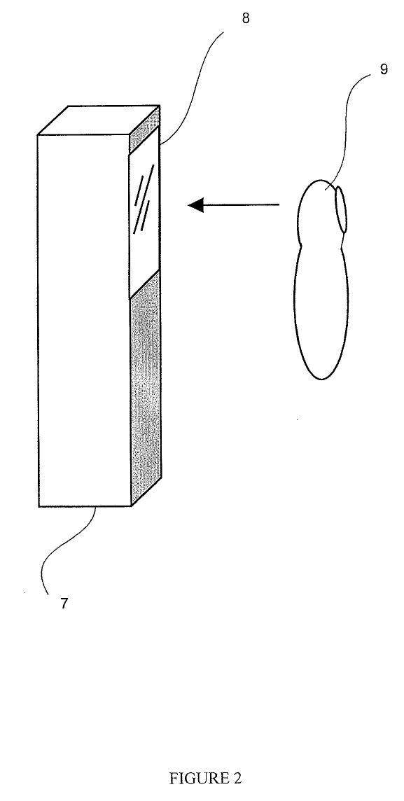

FIG. 2 depicts a perspective view of a safety switch 7 according to an embodiment of the present invention. The safety switch 7 is provided with a biometric sensor module. In this embodiment, the biometric sensor module is provided with a fingerprint reader 8. The fingerprint reader may be, for example, an EntréPad 4000 by AuthenTec, Melbourne USA, or an AT77C101B FingerChip™ by Atmel™ Corporation, San Jose, USA.

In use, a user wishing to enter an enclosure such as that described in relation to FIG. 1a places a finger 9 on the fingerprint reader 8. The fingerprint reader 8 reads the fingerprint of the finger 9 of the user in a known manner.

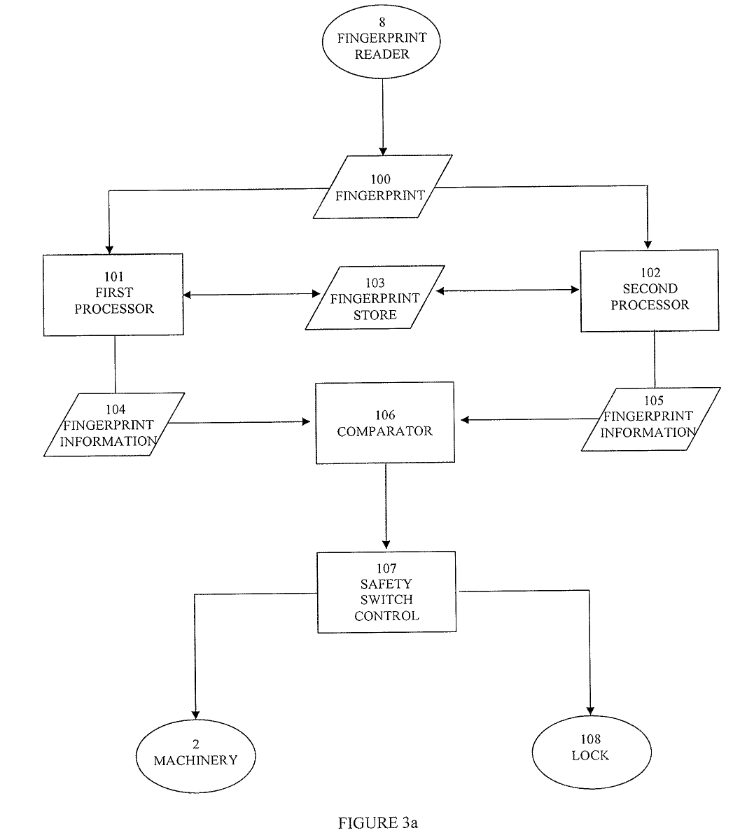

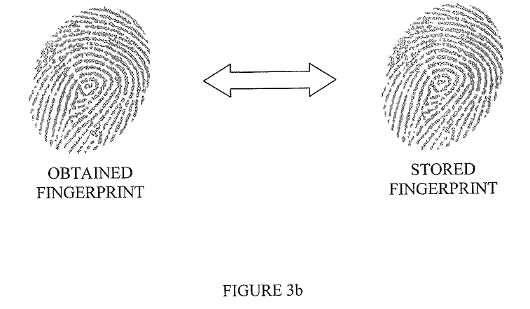

FIG. 3a schematically illustrates the operating principles of the safety switch of FIG. 2. A fingerprint 100 is taken from the fingerprint reader 8. The fingerprint 100 is then interpreted by two processors: a first processor 101 and a second processor 102. The two processors 101, 102 are independent, in that the first processor 101 interprets the fingerprint 100 independently from the second processor 102.

Each processor 101, 102 interprets the fingerprint 100, and references a store of authorised fingerprints 103. Each processor 101, 102 identifies if the obtained fingerprint 100 is an authorised (i.e. stored) fingerprint, and if so, which user it belongs to. FIG. 3b shows how the fingerprint 100 may be compared with a stored fingerprint. Fingerprints may be compared in a known manner, for example by a known software or hardware comparator.

Referring back to FIG. 3a, the processors 101, 102 then pass fingerprint information 104, 105 to a comparator 106. If the fingerprint information 104, 105 sent to the comparator 106 relates to the same authorised user, then the comparator 106 generates a positive signal that is sent to a safety switch control 107. If the comparator 106 does not receive the same fingerprint information 104, 105 from both processors 101, 102, then the fingerprint 100 has not been correctly interpreted by one or both of the processors and a positive signal is not sent to the safety switch control 107. A positive signal is not sent to the safety switch control 107 if either processor 101, 102 identifies the fingerprint 100 as belonging to an unauthorised user.

If the safety switch control 107 receives a positive signal from the comparator 106 the safety switch is activated, and the safety switch control 107 cuts the power to the machinery 2 while simultaneously (or after a short delay) unlocking a lock 108 incorporated in an access door to the enclosure, so that a user may gain access thereto.

By using more than one processor 101, 102 to interpret the fingerprint 100, a verification step is introduced. Only if all of the processors 101, 102 are able to identify the fingerprint 100 as an authorised fingerprint will access to the enclosure be allowed. This is a useful fail-safe if, for example, one of the processors has failed and always deems the obtained fingerprint to be an authorised fingerprint.

The operating principles illustrated in FIG. 3a are given by way of example only. It will be appreciated that any suitable hardware or process configuration may be employed. For example, more than one store of authorised fingerprints 103 may be provided. A fingerprint store 103 may be provided for and accessed by each processor 101, 102. Comparative logic could be provided in each of the processors 101, 102, as opposed to being provided in a comparator 106. If the processors 101, 102 are provided with the comparative logic, there may be no need for the use of a comparator 106. Instead, the processors 101, 102 could communicate directly with the safety switch control 107. The processors 101, 102 could be in communication with one another to ensure that the safety switch is only activated when each processor 101, 102 independently interprets the fingerprint 100 as being that of the same authorised user.

The safety switch 7 of FIG. 2 is provided with a fingerprint reader 8 that may be used by a plurality of users. In an alternative arrangement, each individual user may have an individual fingerprint reader which is connectable to a safety switch. This provides an additional level of security, whereby a user must not only have the correct fingerprint, but must also have access to a fingerprint reader that is connectable to the safety switch.

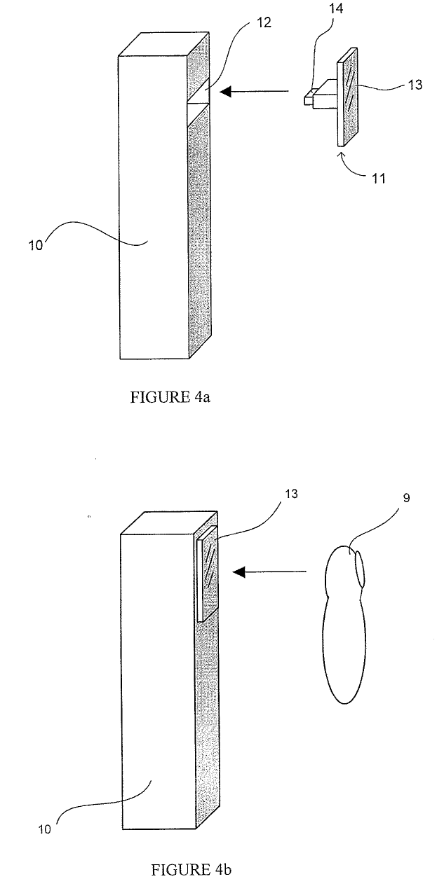

FIGS. 4a and 4b describe a safety switch 10 which is arranged to receive and electrically connect with a removable biometric sensor module 11 via an opening 12 in the safety switch 10.

The biometric sensor module 11 is provided with a fingerprint reader 13 and a connector 14 arranged to be received by the safety switch 10. The connector 14 may be, for example, a Universal Serial Bus (USB) connector, or any other suitable connector.

In use, an authorised user will have a biometric sensor module 11. The biometric sensor module 11 will be brought into engagement with the safety switch 10 such that the fingerprint reader 13 is in electrical connection with the switch 10. Thereafter, the safety switch 10 and the fingerprint reader 13 of FIG. 4b work in exactly the same way as described in relation to the safety switch 7 and the fingertip reader 8 of FIG. 2. After use, the biometric sensor module 11 may be removed from connection with the safety switch.

By providing a safety switch that is able to identify specific (authorised) users, additional benefits beyond the controlled activation of the switch may be realised. For example, once a specific user has activated the switch, control of the switch can be configured such that power cannot be supplied to the machinery until the same specific user has left the enclosure and placed his/her finger on the fingerprint reader, i.e. the biometric sensor module serves as an advanced off-on switch. In this way, another user cannot inadvertently activate the machinery after it has been turned off, even if the other user is an authorised user.

In situations where a high degree of security is required, the safety switch may be configured such that it may only be activated and/or deactivated when more than one fingerprint is used in succession. For example, the safety switch may require the fingerprints of two different authorised users to be activated and/or deactivated. Where a plurality of safety switches are used, for example to control access to one or more enclosures, each safety switch can be configured to allow access to a specific set of authorised users. For example, untrained employees may only be allowed into a first, peripheral enclosure, whereas trained employees may be allowed into a central enclosure, which is more dangerous due to the presence of machinery.

In the above-described embodiments, control circuitry used to obtain the fingerprint, a storage medium for storing authorised fingerprints and a comparator for comparing the obtained fingerprint with the stored fingerprints, may be located in the biometric sensor module, the safety switch or a computer system (e.g. a server) connected to the biometric sensor module and/or the safety switch. By locating the storage medium on a server, which may be remote from the safety switch and fingerprint reader, the store of authorised fingerprints may be centrally managed. This makes it easier to control who is authorised to access the enclosure.

The safety switch may be programmed with a unique identification number. To activate the safety switch the biometric sensor module or the server would have to match the fingerprint data with the switch identification number. This would restrict activation of individual safety switches to certain users. The safety switch could be programmed with the unique identification number and fingerprint data from one individual source (e.g. the computer system or server). The source may be protected from unauthorised access in a conventional manner (e.g. password protection).

An access log may be provided which details authorised and attempted non-authorised use of the safety switch. The access log may be stored in the safety switch, the biometric sensor module or the computer system. Fingerprints of non-authorised users who attempt to activate the switch may be stored so that the non-authorised user can be identified (if necessary) at a later date.

In the case where the biometric sensor module is removable (for example the biometric sensor module 11 of FIG. 4a), the biometric sensor module 11 may be provided with a power source sufficient to activate the safety switch 10. Alternatively, the biometric sensor module 11 may be a passive device.

The embodiments described above have made reference to a fingerprint reader. However, it will be appreciated that any suitable biometric sensor may be used. For example, a retina scanner may be used, or any other biometric sensor that is able to uniquely identify a user by obtaining biological information therefrom. A fingerprint reader is preferable as these devices are cheaper and more reliable than many other biometric sensors. Any suitable fingerprint reader may be used. For example, a fingerprint reader requiring a single impression of a fingerprint may be used. Alternatively, a fingerprint reader requiring a fingerprint to be dragged across a sensor may be used.

Authorised and appropriate (i.e. corresponding to the type of sensor used) biological information may be stored in the biometric sensor module or the safety switch.

It will be appreciated that the present invention is applicable to any safety switch. The above described embodiments have made reference to activating the safety switch. It will be appreciated that the exact nature of the activation will depend on the mechanisms and operation of the safety switch concerned. For example, activation of a safety switch may involve an electrical signal being generated, which causes an electromagnet to be energised that in turn causes a pair of contacts within the safety switch to open. Opening of these contacts may cause a break in a circuit which interrupts the power supplied to machinery within the enclosure. It is to be appreciated, however, that any suitable switch mechanism may be employed.

The above described embodiments have described the biometric sensor module as being in electrical connection with the safety switch or connectable to the safety switch. The connection however may be wireless. For example, the obtained biological information (e.g. a fingerprint) may be transmitted to the safety switch by pressure waves or electromagnetic waves. The electromagnetic waves may be radio waves. In this way, the safety switch may be operated remotely, or may not require an opening that could become contaminated with dirt.

The biometric sensor module make be provided with a radio-wave emitter that is arranged to emit a specific signal (i.e. a signal specific to and therefore identifying an individual biometric sensor module). Only if the fingerprint and radio signal are deemed to be authorised will the switch be activated, i.e. the radio signal acts as a further security check. Alternatively or additionally, the detection by the switch of such a specific radio signal may allow the switch to prepare for an expected user. For example, rather than having to compare the fingerprint with a store of fingerprints, the received radio signal can be used to identify and retrieve a specific fingerprint. When the user tries to access the enclosure using the fingerprint reader, the safety switch need only check that the fingerprint is the one that it is expecting. This may improve the efficiency of checking whether a user is authorised, i.e. make access or denial quicker.

It will be appreciated that an enclosure may be anything which encloses powered apparatus (e.g. machinery), the power supply to which is controlled by a safety switch. An enclosure may be, for example, a room, a cage or a fully or partially fenced off area. The apparatus may be powered electrically, and the supply of electrical power to the machinery may cause activation of a pneumatic or hydraulic system. These systems will also be shutdown when the supply of electrical power to the machinery is interrupted.

It will be appreciated that the above embodiments of the invention have been described by way of example only, and that various modifications may be made to these embodiments without detracting from the invention, which is defined by the claims that follow.

What we claim is:

1. A safety switch arranged to allow the control of power supplied to an apparatus, wherein the safety switch is provided with a biometric sensor module arranged to obtain biological information from a user of the safety switch, such that activation of the safety switch is controlled via the biological information obtained.

2. The safety switch of claim 1 wherein the biometric sensor module comprises a fingerprint reader.

3. The safety switch of claim 1 wherein at least one of the safety switch and the biometric sensor module comprises a first processor arranged to interpret the biological information.

4. The safety switch of claim 3 wherein the at least one of the safety switch and the biometric sensor module comprises a second processor arranged to interpret the biological information.

5. The safety switch of claim 1 further comprising a comparator for comparing the obtained biological information with authorised biological information from one or more users authorised to activate the safety switch.

6. The safety switch of claim 5 wherein the comparator is connected to one of the safety switch and the biometric sensor module.

7. The safety switch of claim 5 further comprising one of a database or storage medium arranged to store the authorised biological information.

8. The safety switch of claim 7 wherein the one of the database or storage medium is operably connected to the biometric sensor module.

9. The safety switch of claim 7 further comprising a server configured to store the authorised biological information.

10. The safety switch of claim 1 wherein the biometric sensor module is removable from the safety switch.

11. The safety switch of claim 1 wherein the biometric sensor module is arranged to provide a signal in the form of at least one of an electrical signal, a pressure wave, and an electromagnetic wave.

12. The safety switch of claim 11 wherein the signal comprises the biological information.

13. The safety switch of claim 1 further comprising a power source connected to the biometric sensor module.

14. The safety switch of claim 1 wherein the safety switch is arranged to allow the control of at least one of pneumatic, hydraulic, or electrical power supplied to an apparatus.

15. A safety switch arranged to control one of operation and access to a machine through receipt of biological information from a biometric sensor module.

16. The safety switch of claim 15 wherein the safety switch is arranged to receive the biometric sensor module.

17. A method of operating a safety switch arranged to allow the control of power supplied to an apparatus, and wherein the safety switch is provided with a biometric sensor module arranged to obtain biological information from a user of the safety switch, such that activation of the safety switch is controlled via the biological information obtained, and wherein the method comprises:
obtaining biological information from a user wishing to activate the safety switch via the biometric sensor module to;
comparing the obtained biological information with authorised biological information from one or more users authorised to activate the safety switch; and
activating the switch if the biological information obtained from the user matches the authorised biological information.

18. A method of claim 17 wherein the switch may only be deactivated if the user who activated the switch provides biological information to the biometric sensor module.

19. The method of claim 17 wherein one of the safety switch and the biometric sensor module compares the obtained biological information with authorised biological information.

20. The method of claim 17 wherein the step of activating the switch further comprises severing or establishing communication of at least one of electrical, hydraulic, and pneumatic power to a machine based on a current condition of the machine.
